(19) United States
(12) Patent Application Publication
(10) Pub. No.: US 2008/0213114 A1
(43) Pub. Date: Sep. 4, 2008

(54) Pump

(76) Inventor: George Miller, Warrington (GB)

Correspondence Address: BAKER & DANIELS LLP, 300 NORTH MERIDIAN STREET, SUITE 2700, INDIANAPOLIS, IN, 46204, US

(21) Appl. No.: 11/918,969

(22) PCT Filed: Apr. 21, 2006
(86) PCT No.: PCT/GB2006/001462

§ 371 Date: Oct. 22, 2007

(30) Foreign Application Priority Data
Apr. 22, 2005 (GB) 0508107.0

(51) Int. Cl. F04B 41/06; B23P 15/00; E21B 43/00

(52) U.S. Cl. 417/521; 29/888.02; 166/372

(57) ABSTRACT

A pump comprising a guide (1) forming a closed loop of variable radius and at least one piston assembly (2). The piston assembly (2) comprises a chamber (4) and a piston (5) slidably mounted within the chamber (4). A first end of the piston assembly (T) is arranged to follow the guide (1) and a second distant end of the piston assembly (2) is mounted proximate the radial centre axis of the loop. At least one of the guide (1) and the piston assembly (2) are arranged to rotate causing relative rotational movement between the guide (1) and the piston assembly (2). The relative rotational movement causes the piston (5) to reciprocally displace within the chamber (4) for pumping a fluid from an inlet (22) to an outlet (20) of the pump.

The present invention relates to a pump. In particular, but not exclusively, the present invention relates to a pump for pumping a fluid that is suitable for operation as a vacuum pump or a compressor.

It is frequently necessary to pump fluids. Such fluids may be gases such as air or liquids such as water. The pumping action may be required to transport the fluid from one location to another. Alternatively, a pump may be required to pressurise a fluid such that the fluid is moved from a first location at a first pressure to a second location at a second, higher pressure. Most commonly, the fluid to be pressurised will be a gas. A pump operates by drawing in a fluid from a first location via a pump inlet and expelling the fluid in a second location via a pump outlet. The pump inlet and outlet typically comprise tubes or passages that connect the two locations via the pump mechanism.

One application for which it is required to pressurise a gas is when a pump is operating as a vacuum pump. A vacuum pump operates by connecting a pump inlet to a sealed chamber to be evacuated and pumping out fluid from within the chamber to a pump outlet, such that fluid pressure in the sealed chamber is reduced.

An alternative application for which it is required to pressurise a gas is when a pump is operating as a compressor. A compressor operates by connecting a pump outlet to a sealed chamber to be pressurised, and pumping a fluid into the chamber (drawing in fluid from a pump inlet), such that the fluid pressure in the sealed chamber is increased.

Known fluid pumps, in particular those operating as vacuum pumps or compressors, are typically complex and involve a large number of moving parts. A large number of moving parts and undue complexity results in a pump that is more expensive to manufacture. Furthermore, such a pump can be more difficult and more expensive to repair.

Many known fluid pumps require a lubricant such as oil to lubricate the surfaces between moving parts. However, a lubricant can contaminate the fluid passing through the pump.

It is an aim of embodiments of the present invention to obviate or mitigate one or more of the problems of the prior art, whether identified herein or elsewhere. Furthermore, it is an aim of embodiments of the present invention to provide a new form of pump suitable for operation as a vacuum pump, a compressor or simply to displace fluid.

According to a first aspect of the present invention there is provided a pump comprising: a guide forming a closed loop of variable radius; and at least one piston assembly comprising a chamber and a piston slidably mounted within the chamber; wherein a first end of the piston assembly is arranged to follow the guide and a second distant end of the piston assembly is mounted proximate the radial centre axis of the loop, at least one of the guide and the piston assembly being arranged to rotate such that relative rotational movement between the guide and the piston assembly causes the piston to reciprocally displace within the chamber for pumping a fluid from an inlet to an outlet of the pump.

In such an arrangement, as the first end of the piston assembly is arranged to automatically follow the guide, when relative rotational movement occurs between the piston assembly and the guide, fluid can be pumped from a pump inlet to a pump outlet. Such a pump therefore has the advantage of requiring a small number of moving parts in order to pump fluid.

Preferably, the first end of the piston assembly is arranged to rotate relative to the radial centre axis such that the piston is biased towards the guide, and as the first end of the piston assembly follows the guide the distance between the first end and the second end alternately increases and decreases such that the piston is reciprocally displaced.

Preferably, the first end of the piston assembly comprises a wheel arranged to roll along a surface of the guide as the piston assembly rotates such that the first end of the piston assembly follows the guide.

Preferably, the closed loop is elliptical.

Preferably, the first end of the piston assembly comprises the piston and the second end of the piston assembly comprises the chamber.

Preferably, the first end of the piston assembly comprises the chamber and the second end of the piston assembly comprises the piston.

Preferably, the second end of the piston assembly is rotatable about a shaft comprising at least one passage, said at least one passage being connected to at least one respective radially extending shaft aperture, the piston assembly further comprising at least one chamber aperture connected to the chamber said apertures being positioned such that as the piston assembly rotates the chamber is connected to the passage during at least part of each rotation via coupling of the chamber aperture and the shaft aperture.

Preferably, the shaft comprises at least a first and a second of such passages and the piston assembly comprises at least a first and a second of such chamber apertures, the apertures being positioned such that fluid is drawn into the chamber from the first passage via the first chamber aperture and fluid is pumped from the chamber to the second passage via the second chamber aperture.

Preferably, the shaft comprises at least one passage connected to the pump inlet and at least one passage connected to the pump outlet, said passages being arranged such that as the piston assembly rotates the chamber is connected to the pump inlet and the pump outlet during at least part of each rotation.

Preferably, the pump further comprises a rotor connecting together a plurality of said piston assemblies. More preferably, the rotor is arranged such that the second end of each piston assembly is rotatable about a shaft, and the rotor is arranged in radially opposed pairs of piston assemblies about the shaft. The pump may comprise a plurality of rotors.

The pump may comprises at least two piston assemblies wherein the chamber of a first piston assembly is connected to the chamber of a second piston assembly during at least part of each rotation such that fluid is pumped from one chamber to the other.

The pump may be a vacuum pump. Alternatively, the pump may be a compressor. The pump may further comprise a one way valve on the outlet arranged to allow fluid to be pumped out of the pump. The pump may further comprise a one way valve on the inlet arranged to allow fluid to be drawn into the pump.

Preferably, the pump is arranged to pump a gas.

Preferably, the piston assembly further comprises a piston ring arranged to provide a substantially fluid proof seal between the piston and the chamber. The piston ring may be formed of a material comprising at least one of molybdenum disulphide impregnated nylon and bronze impregnated PTFE.

The wheel may be formed of a material comprising at least one of molybdenum disulphide impregnated nylon and bronze impregnated PTFE.

Preferably, the pump is arranged to pump fluid at a pump rate of between 1 m³/hour and 100 m³/hour. Preferably, the pump is arranged to compress the fluid between the inlet and the outlet at a compression ratio of between 1 and 100.

According to a second aspect of the present invention there is provided a method of manufacturing a pump comprising providing: a guide forming a closed loop of variable radius; and at least one piston assembly comprising a chamber and a piston slidably mounted within the chamber; and assembling the guide and the at least one piston assembly such that a first end of the piston assembly is arranged to follow the guide and a second distant end of the piston assembly is mounted proximate the radial centre axis of the loop, at least one of the guide and the piston assembly being arranged to rotate such that relative rotational movement between the guide and the piston assembly causes the piston to reciprocally displace within the chamber for pumping a fluid from an inlet to an outlet of the pump.

According to a third aspect of the present invention there is provided a method of pumping a fluid, the pump comprising: a guide forming a closed loop of variable radius; and at least one piston assembly comprising a chamber and a piston slidably mounted within the chamber, a first end of the piston assembly being arranged to follow the guide and a second distant end of the piston assembly being mounted proximate the radial centre axis of the loop; the method comprising rotating at least one of the guide and the piston assembly such that relative rotational movement between the guide and the piston assembly causes the piston to reciprocally displace within the chamber pumping a fluid from an inlet to an outlet of the pump.

Embodiments of the present invention will now be described, by way of example only, with reference to the accompanying drawings in which:

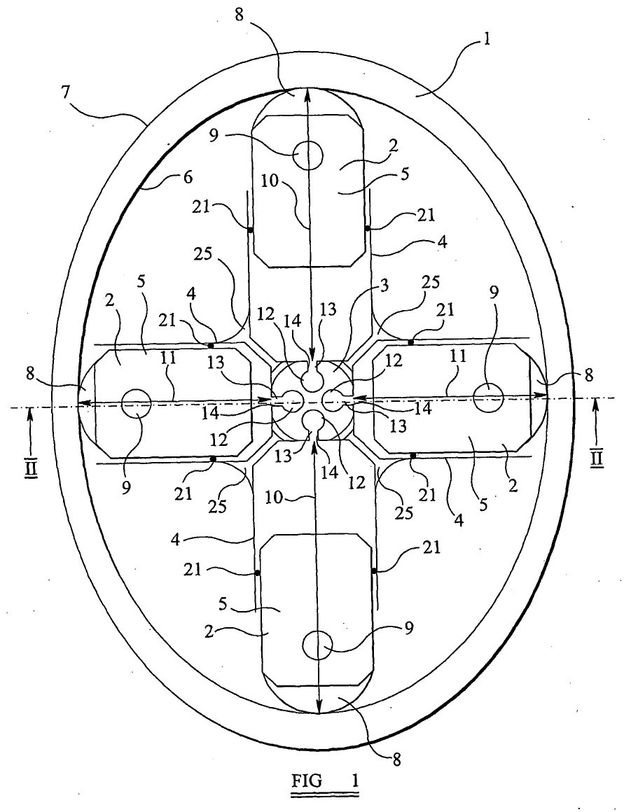

FIG. 1 illustrates a schematic plan view in cross section of a pump in accordance with an embodiment of the present invention;

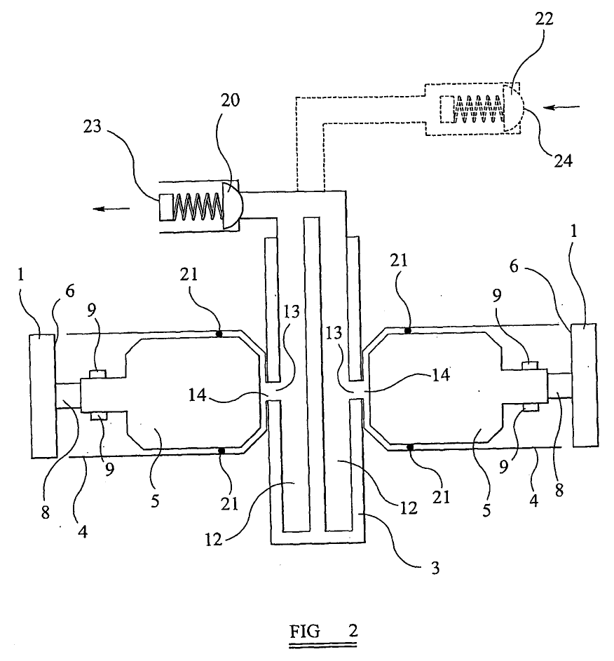

FIG. 2 illustrates a schematic view in partial cross section of the pump of FIG. 1, when operating as a vacuum pump, along the line II:II in the direction of the arrows;

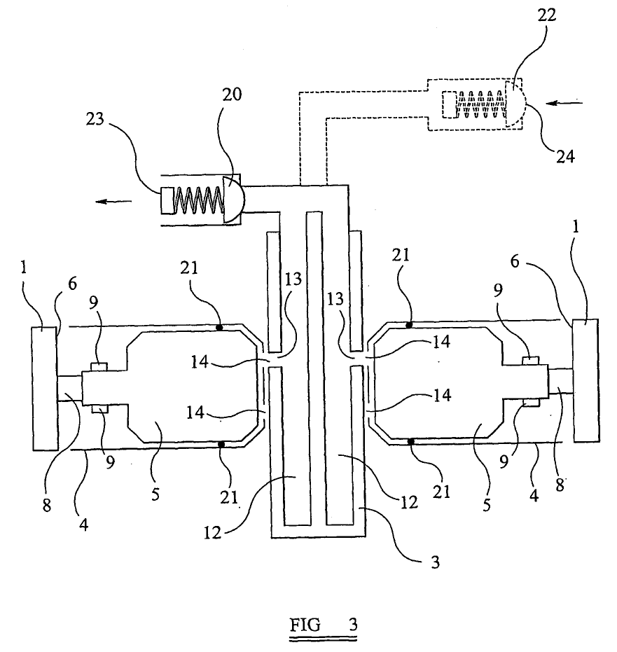

FIG. 3 illustrates a schematic view in partial cross section of a pump in accordance with a further embodiment of the present invention;

FIGS. 4a, 4b and 4c schematically illustrate alternative shapes of guides for pumps in accordance with embodiments of the present invention;

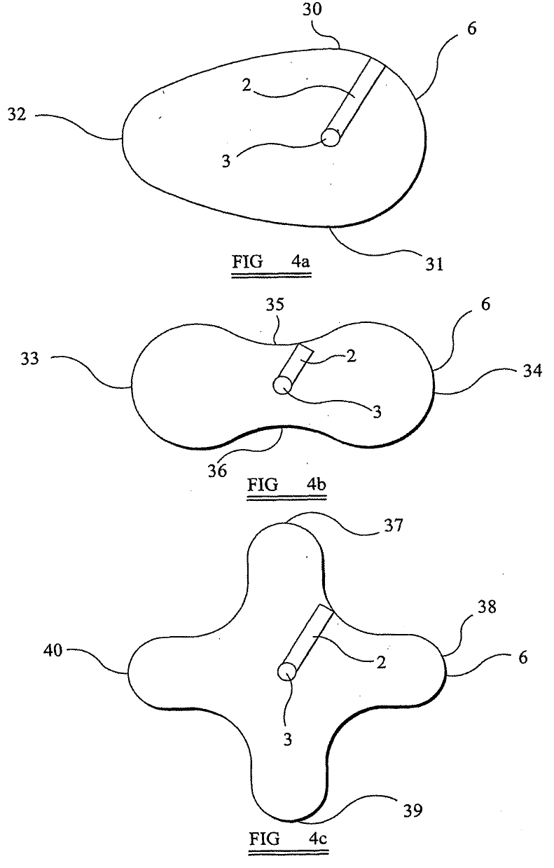

FIG. 5 illustrates a schematic plan view in cross section of a pump in accordance with an alternative embodiment of the present invention;

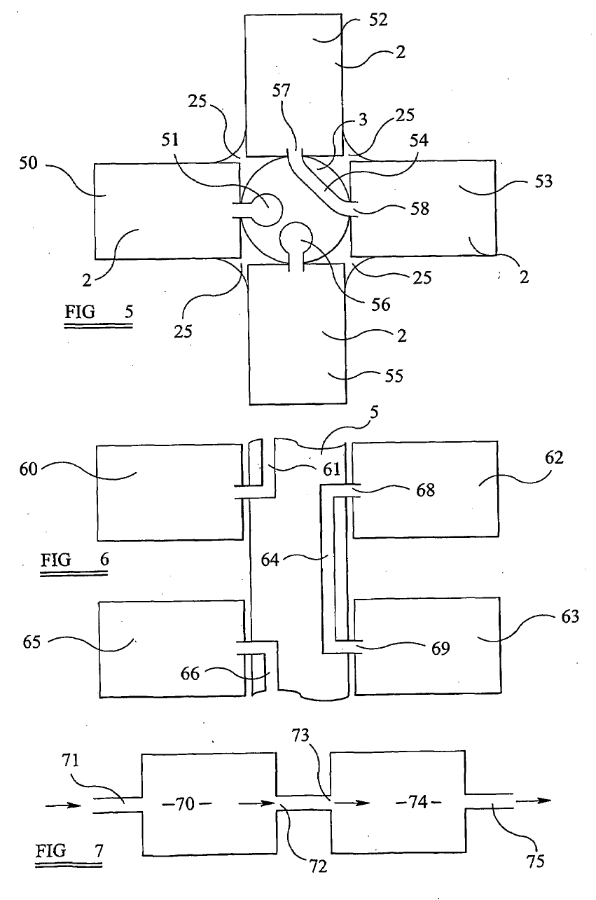

FIG. 6 illustrates a schematic side view in cross section of a pump in accordance with a further alternative embodiment of the present invention; and

FIG. 7 illustrates a schematic view of a pump in accordance with a further alternative embodiment of the present invention.

Referring first to FIG. 1, this illustrates a guide 1 forming a closed loop and four piston assemblies 2 rotatably mounted about a shaft 3. The piston assemblies 2 are arranged to rotate about the shaft 3. The piston assemblies 3 are mounted together on a rotor 25 such that they rotate together about the shaft 3. The rotor 25 comprises a metal frame fixing each piston assembly to its neighbours. The assemblies 3 are driven by a rotary motor (not shown) to rotate about the shaft 3, with the shaft 3 remaining fixed. The axis of shaft 3 is approximately located at the radial centre axis of the guide 1.

Each piston assembly 2 comprises a chamber 4 and a piston 5 slidably mounted within the chamber 4. Each chamber 4 comprises a hollow walled cavity, open at one end into which the piston is slidably mounted. The piston comprises a disc or plug of material arranged to completely or substantially completely block off the open end of the chamber. As the piston 5 slides within the chamber, the volume of chamber effectively sealed off by the piston varies. Each chamber is typically a cylinder open at one end into which a cylindrical piston is received. However, the chamber (and piston) may be of any other shape, for instance for ease of manufacture. In order to seal the gap between the chamber 4 and the piston 5 as the piston slides within the chamber, at least one piston ring 21 is mounted on each piston. The guide 1 has an inner surface 6 and an outer surface 7. Pistons 5 each incorporate a wheel 8 arranged to roll along the inner surface 6 of guide 1 such that the wheel follows the guide 1. Wheels 8 are rotatably mounted to the pistons 5 via axles 9. In this particular embodiment each piston 5 defines a first end of each piston assembly 2. The first end follows the inner surface 6 of guide 1 as the piston assemblies 2 rotate. The chamber 4 defines a second end, which rotates relative to the radial centre axis of guide 1 about shaft 3.

As the piston assemblies 2 rotate about shaft 3 the pistons 5 (and the wheels 8) are biased towards the guide 1, as the mass of each piston 5 is accelerated away from shaft 3, i.e. the pistons are biased by the so-called “centrifugal force”. The inner surface 6 of guide 1 is arranged to limit the radial motion of the pistons 5 such that the first ends of piston assemblies 2 follow the inner surface 6 as the assemblies rotate. At any instant during the rotation of the piston assemblies 2 the maximum length of each piston assembly is limited by the distance between the shaft 3 and the inner surface 6 of the guide 1. Therefore, due to the shape of guide 1, as each piston assembly 2 rotates the piston 5 reciprocally displaces within the chamber 4.

The inner surface 6 of guide 1 forms a continuous surface. The inner surface 6 is of variable radius. The term variable radius is used to mean that guide 1 is a fixed shape, the radius of which vanes, as measured from the centre position of the guide, e.g. the centre of the shaft 3, to the inner surface 6, along the path swept by the first ends of the piston assemblies 2. Specifically, the inner surface 6 of guide 1 forms an ellipse. As the piston assemblies 2 rotate, with the first ends following the inner surface 6 of guide 1, the length of the piston assemblies between the first and second ends alternately increases and decreases from a maximum length 10 to a minimum length 11 as each piston assembly 2 moves between alignment with the major radius of the ellipse and the minor radius of the ellipse.

Internal to the shaft 3 are a number of passages 12, extending parallel to the axis of the shaft 3. Passages 12 connect with radially extending shaft apertures 13. The chambers 4 of piston assemblies 2 also include chamber apertures 14. As the piston assemblies 2 rotate the chamber apertures 14 are brought into contact and thereby coupled together with the shaft apertures 13 for at least part of each rotation. When the shaft apertures 13 and the chamber apertures 14 are coupled together fluid can pass from the chamber 4 into the passages 12 and vice versa.

The shaft apertures 13 are arranged such that as each piston assembly 2 is extending towards its maximum length 10, the chamber 4 is coupled to a passage allowing fluid to be drawn into the chamber 4 from the passage. Conversely, when the piston assembly 2 is shortening, the chamber 4 is connected to a separate fluid passage 12 via a different shaft aperture 13, allowing fluid to be pumped from the chamber 4 to the passage.

The piston assemblies 2 are arranged in two radially opposed pairs such that at any instance during the rotation of the piston assemblies, two piston assemblies are increasing in length and two piston assemblies are decreasing in length. In order to accommodate the changing volume of the chambers 4 in each piston assembly 2 there are four passages 12 passing along the length of the shaft 3 each connecting to a separate shaft aperture 13. The shaft passages 12 are arranged in radially opposite pairs. Two passages connect to the pump inlet and two shaft passages connect to the pump outlet. Therefore, as the piston assemblies 2 rotate, fluid is pumped from a first pair of shaft passages 12 into a first pair of chambers 4 and fluid is pumped into the other pair of shaft passages from the other pair of chambers 4.

As each piston assembly 2 rotates the portion of chamber 4 sealed off by piston 5 will be effectively alternately increasing and decreasing in volume (due to the movement of the piston 5). The piston assembly 2 draws in fluid twice and pumps out fluid twice during each full rotation about shaft 3. As the piston assembly 2 rotates its chamber aperture will couple to each shaft aperture in turn. The relative sizes and locations of the shaft apertures 13 and the chamber apertures 14 determine the portion of each rotation for which the chamber 4 draws in or pumps out fluid.

A pump as described herein (e.g. arranged to pump fluid at a pump rate of approximately 10 m³/hr), can have a maximum extended piston assembly length within the range 5 cm to 15 cm. The minimum piston assembly length is typically 60% to 80%, for instance about 70% of the maximum extended piston assembly length. However, the pump is not limited to these dimensions. The pump may range in size from nanometre scale to several metres, or larger.

When a piston assembly is rotating from a position of maximum length 10 to minimum length 11 the fluid within the chamber 4 is compressed before being released by coupling to a shaft passage 12. The ratio of the effective volumes of the chamber 4 (i.e. the portion of the chamber 4 sealed off by the piston) corresponding to maximum extended piston assembly length and minimum piston assembly length determine the compression ratio of the pump. The pump of FIG. 1 may typically provide a compression ratio of 50 for a pump having a maximum extended piston assembly length of approximately 11.5 cm and a minimum piston assembly length of 8 cm. That is, fluid drawn into chamber 4 as the chamber expands will be compressed by up to a factor of 50 as the chamber contracts. The compression ratio may be increased by increasing the difference in length between a piston assembly at maximum extent and one at its minimum extent. In alternative embodiments of the present invention, the compression ratio may vary between 10 and 100. In further alternative embodiments, the compression ratio may vary between 1 and 100.

The pump of FIG. 1 may be operated as a vacuum pump. Typically, the pressure at the pump inlet may be reduced to 0.01 mBar. The pump rate of a pump is defined as the volume of fluid pumped by the pump per unit time. The volume of fluid pumped may be measured at the inlet or the outlet of the pump. For a pump arranged to compress the fluid the volume of fluid pumped measured at the inlet may differ from that measured at the outlet. The pump rate for the pump of FIG. 1 may typically vary from 5 m³/hour to 40 m³/hour. However, the range of pump rates for a pump in accordance with the present invention can vary from 1 m³/hour, or less, to over 100 m³/hour. In one preferred embodiment of the present invention the fluid drawn into and pumped out of each piston assembly 2 each time the piston assembly 2 extends and contracts is 60 cm³. This equates to 10.6 m³/hour at a typical rotation rate. Typically, such a pump rotates at approximately 1500 rpm.

FIG. 2 shows a partial cross sectional view of the pump of FIG. 1. Identical numbering is used to refer to similar components illustrated in both FIGS. 1 and 2. If the pump is operating as a vacuum pump, a one way valve, such as a poppet valve 20, is typically connected to the pump outlet 23, as shown in FIG. 2, in order to prevent higher pressure fluid from re-entering the pump via the outlet. If the pump is operating as a compressor a poppet valve 22 is typically connected to the pump inlet 24 in order to prevent higher pressure fluid from escaping from the pump via the inlet. FIG. 2 illustrates poppet valve 22 and pump inlet in dotted outline as in normal operation the pump will only have a poppet valve on the outlet or the inlet depending upon whether the pump is operating as a vacuum pump or a compressor respectively. However, it will be appreciated that a pump in accordance with the present invention may have poppet valves on both the pump inlet and the pump outlet.

A poppet valve is a form of one way valve comprising an aperture and a spring biased disc or plug arranged to press against the aperture to close of the passage. Fluid pressure acting against the disc or plug serves to close off the passage to fluid if the fluid is at a higher pressure on the side of the valve away from the aperture.

If the pump of FIG. 1 is operated as a compressor the pressure at the pump outlet may be increased to 50 Bar, if the pump inlet is connected to a volume of gas at atmospheric pressure.

It is preferable that each piston chamber 4 incorporates two chamber apertures 14 at different positions along the longitudinal axis of the shaft 3. This is illustrated in FIG. 3, which is otherwise identical to FIG. 2 and therefore identical numbering is used throughout to refer to similar features. This is desirable as it allows fluid to be drawn into and expelled from the chamber 4 via separate chamber apertures 14. The corresponding shaft apertures may therefore be separated along the length of the shaft 3 such that they couple with the appropriate chamber apertures 14 in order to connect the chamber 4 to the correct passage 12 at the correct time. Separating the shaft apertures 13 along the length of the shaft 3 allows for more freedom in arranging the relative sizes and positions of the shaft apertures 13 in order to determine the relative timing of the coupling to the chamber apertures 14. In the position shown, the upper apertures 14 are connected to respective shaft apertures 13. In an alternative position (not shown), the piston assemblies have rotated, such that the lower apertures are coupled to respective shaft apertures 13, and the upper apertures are occluded.

Typically the fluid pumped by a pump in accordance with an embodiment of the present invention will be a gas. Most commonly, the gas will be air, in particular when the pump is used as a vacuum pump to evacuate a chamber.

A pump as described herein may advantageously be manufactured such that it is capable of running “dry”, that is without requiring lubricants in order to prevent friction between the chambers 4 and the pistons 5. This is desirable in order to prevent the lubricant contaminating the fluid. This may be achieved by providing piston rings of a hard wearing, tough material as in order to provide a good fluid seal the piston ring must fit tightly. This accordingly can generate a large amount of friction. Preferably the piston ring comprises a material having a low coefficient of friction. Suitable materials include molybdenum disulphide impregnated nylon and bronze impregnated Polytetrafluorethylene (PTFE). These materials are particularly suitable as they are commercially available. However, it will be readily apparent that there are many other suitable materials having similar properties.

The wheels 8 are also subjected to considerable amounts of friction as they roll around the inner surface 6 of the guide 1. Accordingly, they are preferably manufactured from similar hard wearing materials as the piston rings.

All other components of the pump may conveniently be manufactured of aluminium as this is a relatively cheap and easily machinable material. All drive components used to rotate the piston assemblies, and other components such as bearings, may conveniently use standard commercially available components.

Although the above embodiment has been primarily described in the context of pumping air it will be readily appreciated that a pump as described herein may be arranged to pump any form of fluid, for instance any other gas or any liquid such as water.

The arrangement of the guide 1 and the piston assemblies 2 as described above, in which a wheel 8 forming part of each piston assembly is arranged to roll around the inside surface 6 of the guide 1 is merely illustrative of one preferred embodiment of the present invention. For instance, the wheels may be replaced with skids that slide rather than roll along the inner surface of the guide.

In the above described embodiment, the guide limits the maximum extent of the piston assemblies, and the rotation of the piston assemblies accelerates the mass of the pistons 5 outwards biasing the first ends of the piston assemblies towards the guide. In an alternative embodiment the guide may form a rail such that a wheel attached to the piston assembly rolls around the outside of the guide. In such an embodiment, the guide forces the piston assemblies to extend as the radius of the ellipse increases. There may be a second rail arranged to force the piston assemblies to shorten, such that the guide forms a pair of rails with the wheel rolling between the pair. Alternatively, there may be a single rail with each piston assembly further comprising a pair of wheels, one on either side of the rail to force the piston assembly to extend and shorten. Such a guide arrangement may be preferable when the pump is arranged to pump a more viscous fluid than air, such as water. A more viscous fluid will tend to limit the rate at which a chamber can expand or contract such that for the above described pump the first end of the pump would not be in contact with the guide for the whole of each rotation.

For the above modification having two guide rails arranged to constrain the wheels to force the piston assemblies to lengthen and shorten the pump could be further modified in that instead of the piston assemblies rotating around the shaft the guide rotates around the piston assemblies. Furthermore, the pump could be further modified in that the pistons and the chambers are swapped around.

Alternatively, the piston 5 may be biased outwards by a spring or other resilient member. The end of the piston assembly remote from the shaft 3 would therefore be urged into contact with the inner surface 6 of the guide 1

The guide need not always be formed as an ellipse. Indeed the guide may be of any shape having a variable radius. The number of extensions and contractions each piston assembly experiences as it rotates around the shaft can vary with the shape of the guide.

The phrase “alternately increases and decreases” is used in a broad sense. The phrase is intended to include a scenario in which the length of the piston assembly 2 during an increasing portion of the rotation is generally increasing but the increase can be temporarily interrupted. During this part of the increasing portion the piston assembly is constant in length. Similarly, the piston assembly 2 may be temporarily constant in length during part of the decreasing portion of the rotation. As the length of the piston assembly 2 varies, the space within the portion of the chamber 4 closed off by the piston 5 increases and decreases.

FIGS. 4a, 4b and 4c schematically illustrate alternative shapes of guides. Piston assembly 2 is shown rotating about shaft 3 with the end distant from the shaft 3 following the inner surface 6 of the guide 1.

FIG. 4a illustrates an egg-shaped guide having a portion between points 30 and 31 during which the length of each piston assembly 2 will neither increase nor decrease (when the end distant from the shaft 3 is in the right hand half of the guide). During each rotation each piston assembly will extend once to a maximum length at point 32 before contracting again.

FIG. 4b illustrates an alternative guide shape, formed from two overlapping ellipses or egg-shapes having a greatly increased compression ratio, due to the increased difference between the maximum length of the piston assemblies at points 33 and 34 and the minimum length at points 35 and 36.

FIG. 4c illustrates an alternative guide shape, which approximates two crossed ellipses for which each piston assembly will extend and contract four times during each full rotation (as opposed to the two extensions and contractions for an ellipse). Each piston assembly will extend to its maximum extent at points 37, 38, 39 and 40.

It will be appreciated that many other shapes of guide may be envisaged with varying properties. FIGS. 4a, 4b and 4c are merely illustrative of the variability of guide shape that is possible.

A further preferable feature is that the shaft passages 12 are arranged such that the chamber 4 of a first piston assembly 2 that is decreasing in volume is coupled to the chamber 4 of a second piston assembly that is increasing in volume. This allows the already pressurised fluid in the first chamber to be passed into the second chamber, whereupon it is further pressurised. The second chamber need not be the same size as the first chamber. Indeed, it is preferable that the second chamber is smaller than the first chamber. This is because the pressurised fluid from the first chamber occupies a smaller volume than the maximum size of the first chamber. The second chamber can be arranged such that its maximum size is comparable to the minimum size of the first chamber, to prevent the pressurised fluid from expanding as it enters the second chamber. Additionally, this reduction in size from the first chamber to the second chamber facilitates the passage of fluid from the first chamber through to the outlet. This “multistage linking” can be extended such that the second piston is connected to further pistons. The effect is equivalent to increasing the compression ratio of each piston assembly 2. When operating as a vacuum pump a pump according to FIG. 1 modified in this manner has been shown to reduce the pressure at the inlet to 0.1 mBar when the outlet is connected to a source of gas at atmospheric pressure.

FIG. 5 schematically illustrates multistage linking. Rotor 25 connects four piston assemblies 2 rotating about shaft 3. A first piston assembly 50 is shown connected to a shaft passage 51 connected to the pump inlet. A second piston assembly 52 is shown connected to a third piston assembly 53 by a shaft passage 54. A fourth piston assembly 55 is connected to a shaft passage 56 connected to the pump outlet. As the rotor 25 rotates, the four piston assemblies will move such that they are connect to different shaft passages. The piston assembly connected to shaft passage 51 draws in uncompressed fluid from the pump inlet. This fluid is then compressed and pumped out when the piston assembly is connected to a first end 57 of shaft passage 54. This occurs as the piston assembly connected to a second end 58 of shaft passage 54 is arranged to be drawing in fluid. This next piston assembly draws in the already compressed fluid from the second end 58 of shaft passage 54. This fluid will then be further compressed until the piston assembly moves round into connection with shaft passage 56, connected to the pump outlet. As such the fluid in shaft passage 56 has been compressed twice.

There may be any number of piston assemblies. The greater the number of piston assemblies provided, the smoother the flow of pumped fluid will be. However, it is advantageous to arrange the piston assemblies in radially opposed pairs such that the piston assemblies are balanced as they rotate at speed. The piston assemblies are in arranged in balanced pairs connected by the or each rotor. For instance, FIG. 1 illustrates two pairs of balanced piston assemblies connected together by rotor 25. This reduces any vibration within the pump, resulting in a quieter pump and less wear. The piston assemblies need not all be in the same plane. In fact, if the piston assemblies are distributed along the length of the shaft, connected together in groups by a plurality of rotors, then this makes it easier to incorporate a greater number of piston assemblies. The piston assemblies in different planes may be controlled by the same guide. Alternatively, the piston assemblies in different planes may be controlled by separate guides, which may be offset from each other or different shapes.

FIG. 6 schematically illustrates multistage linking between two piston assemblies on separate rotors rotating about shaft 3. A first piston assembly 60 is shown connected to a shaft passage 61 connected to the pump inlet. A second piston assembly 62 is shown connected to a third piston assembly 63 by a shaft passage 64. A fourth piston assembly 65 is connected to a shaft passage 66 connected to the pump outlet. As the rotors rotate, the four piston assemblies will move such that they are connect to different shaft passages and a new set of piston assemblies will be connected to the shaft passages 61, 64, 66. The piston assembly connected to shaft passage 61 draws in uncompressed fluid from the pump inlet. The piston assembly connected to a first end 68 of shaft passage 64 pumps out compressed fluid. This occurs when the piston assembly connected to a second end 69 of shaft passage 54 is arranged to be drawing in fluid. This next piston assembly draws in the already compressed fluid from the second end 69 of shaft passage 64. The fluid is then further compressed. The piston assembly connected to shaft passage 66, connected to the pump outlet pumps out fluid that has been compressed twice.

FIG. 7 illustrates a further option for multi-stage linking. A first pump 70, which may be as shown in FIG. 1, draws in fluid from a pump inlet 71 and pumps out compressed fluid at a pump outlet 72. The pump outlet 72 is connected to a pump inlet 73 of a second pump 74, which again may be as shown in FIG. 1. Second pump further compresses the fluid and pumps it out from pump outlet 75.

It will be appreciated that the above three options for multi-stage linking may be applied to a pump as described herein many times, and in any combination, in order to increase the compression ratio of the pump.

There may be any number of shaft passages arranged to transfer fluid between the chambers and the inlet/outlet. Also, as described above the passages may be arranged to cross link the chambers of two piston assemblies together to increase the pressure difference between the inlet and the outlet. The precise arrangement of the passages will depend on how the pump is to be used, the number and position of the piston assemblies and the shape of the guide.

In the above described pump, the first end of each piston assembly, i.e. that arranged to follow the guide, comprises the piston (together with the wheel), and the second end rotatably mounted about the shaft comprises the chamber. This requires that as each piston assembly rotates the chamber remains in a constant radial position relative to the shaft and the piston is reciprocally radially displaced. It will be appreciated that the relative radial positions of the piston and the chamber could be reversed, i.e. the chamber end could be arranged to follow the guide.

The motor is conveniently a pancake motor, arranged to lie parallel to the plane of rotation of the or each piston assembly. This reduces the overall volume of the pump/rotor combination. Furthermore, the motor may be a variable speed motor, such that on starting up the pump, the pump is incrementally spun up to the desired operating speed. This can reduce wear on the motor and the pump.

Further modifications, and applications of the present invention will be readily apparent to the appropriately skilled person without departing from the scope of the appended claims.

1. A pump comprising:
a guide forming a closed loop of variable radius; and
at least one piston assembly comprising a chamber and a piston slidably mounted within the chamber;
wherein a first end of the piston assembly is arranged to follow the guide and a second distant end of the piston assembly is mounted proximate the radial centre axis of the loop, at least one of the guide and the piston assembly being arranged to rotate such that relative rotational movement between the guide and the piston assembly causes the piston to reciprocally displace within the chamber for pumping a fluid from an inlet to an outlet of the pump.

2. A pump according to claim 1, wherein the first end of the piston assembly is arranged to rotate relative to the radial centre axis such that the piston is biased towards the guide, and as the first end of the piston assembly follows the guide the distance between the first end and the second end alternately increases and decreases such that the piston is reciprocally displaced.

3. A pump according to claim 1 or 2, wherein the first end of the piston assembly comprises a wheel arranged to roll along a surface of the guide as the piston assembly rotates such that the first end of the piston assembly follows the guide.

4. A pump according to any one of the preceding claims, wherein the closed loop is elliptical.

5. A pump according to any one of the preceding claims, wherein the first end of the piston assembly comprises the piston and the second end of the piston assembly comprises the chamber.

6. A pump according to any one of claims 1 to 4, wherein the first end of the piston assembly comprises the chamber and the second end of the piston assembly comprises the piston.

7. A pump according to any one of claims 2 to 6, wherein the second end of the piston assembly is rotatable about a shaft comprising at least one passage, said at least one passage being connected to at least one respective radially extending shaft aperture, the piston assembly further comprising at least one chamber aperture connected to the chamber said apertures being positioned such that as the piston assembly rotates the chamber is connected to the passage during at least part of each rotation via coupling of the chamber aperture and the shaft aperture.

8. A pump according to claim 7, wherein the shaft comprises at least a first and a second of such passages and the piston assembly comprises at least a first and a second of such chamber apertures, the apertures being positioned such that fluid is drawn into the chamber from the first passage via the first chamber aperture and fluid is pumped from the chamber to the second passage via the second chamber aperture.

9. A pump according to claim 7 or claim 8, wherein the shaft comprises at least one passage connected to the pump inlet and at least one passage connected to the pump outlet, said passages being arranged such that as the piston assembly rotates the chamber is connected to the pump inlet and the pump outlet during at least part of each rotation.

10. A pump according to any one of the preceding claims, comprising a rotor connecting together a plurality of said piston assemblies.

11. A pump according to claim 10, wherein the rotor is arranged such that the second end of each piston assembly is rotatable about a shaft, and the rotor is arranged in radially opposed pairs of piston assemblies about the shaft.

12. A pump according to claim 10 or claim 11, further comprising a plurality of rotors.

13. A pump according to claim 7, further comprising at least two piston assemblies wherein the chamber of a first piston assembly is connected to the chamber of a second piston assembly during at least part of each rotation such that fluid is pumped from one chamber to the other.

14. A pump according to any one of the preceding claims, wherein the pump is a vacuum pump.

15. A pump according any one of claims 1 to 13, wherein the pump is a compressor.

16. A pump according to claim 14 or claim 15, further comprising a one way valve on the outlet arranged to allow fluid to be pumped out of the pump.

17. A pump according to claim 14 or claim 15, further comprising a one way valve on the inlet arranged to allow fluid to be drawn into the pump.

18. A pump according to any one of the preceding claims, wherein the pump is arranged to pump a gas.

19. A pump according to any one of the preceding claims, wherein the piston assembly further comprises a piston ring arranged to provide a substantially fluid proof seal between the piston and the chamber.

20. A pump according to claim 19, wherein the piston ring is formed of a material comprising at least one of molybdenum disulphide impregnated nylon and bronze impregnated PTFE.

21. A pump according to any one of claims 3 to 20, wherein the wheel is formed of a material comprising at least one of molybdenum disulphide impregnated nylon and bronze impregnated PTFE.

22. A pump according to any one of the preceding claims, wherein the pump is arranged to pump fluid at a pump rate of between 1 m³/hour and 100 m³/hour.

23. A pump according to any one of the preceding claims, wherein the pump is arranged to compress the fluid between the inlet and the outlet at a compression ratio of between 1 and 100.

24. A method of manufacturing a pump comprising providing:
a guide forming a closed loop of variable radius; and
at least one piston assembly comprising a chamber and a piston slidably mounted within the chamber;
and assembling the guide and the at least one piston assembly such that a first end of the piston assembly is arranged to follow the guide and a second distant end of the piston assembly is mounted proximate the radial centre axis of the loop, at least one of the guide and the piston assembly being arranged to rotate such that relative rotational movement between the guide and the piston assembly causes the piston to reciprocally displace within the chamber for pumping a fluid from an inlet to an outlet of the pump.

25. A method of pumping a fluid, the pump comprising:
a guide forming a closed loop of variable radius; and
at least one piston assembly comprising a chamber and a piston slidably mounted within the chamber, a first end of the piston assembly being arranged to follow the guide and a second distant end of the piston assembly being mounted proximate the radial centre axis of the loop;
the method comprising rotating at least one of the guide and the piston assembly such that relative rotational movement between the guide and the piston assembly causes the piston to reciprocally displace within the chamber pumping a fluid from an inlet to an outlet of the pump.

26. A pump, substantially as hereinbefore described, with reference to the accompanying drawings.

27. A method of manufacturing a pump, substantially as hereinbefore described, with reference to the accompanying drawings.

28. A method of pumping a fluid, substantially as hereinbefore described, with reference to the accompanying drawings.
